(19) United States
(12) Patent Application Publication
(10) Pub. No.: US 2017/0107868 A1
(43) Pub. Date: Apr. 20, 2017

(54) HYDRAULIC CAMSHAFT ADJUSTER, USE OF A ROTOR HAVING AT LEAST TWO PARTS AND METHOD FOR OPERATING A HYDRAULIC CAMSHAFT ADJUSTER

(71) Applicant: Schaeffler Technologies AG & Co. KG, Herzogenaurach (DE)

(72) Inventors: Rainer OTTERSBACH, Aurachtal (DE); Juergen WEBER, Erlangen (DE)

(21) Appl. No.: 15/311,437

(22) PCT Filed: Apr. 7, 2015
(86) PCT No.: PCT/DE2015/200248

§ 371 Date: Nov. 15, 2016

(30) Foreign Application Priority Data
May 15, 2014 (DE) 10 2014 209 181.0

(51) Int. Cl. F01L 1/344; F16H 53/04

(52) U.S. Cl. CPC F01L 1/3442; F16H 53/04

(57) ABSTRACT

A hydraulic camshaft adjuster (1) having a rotor (2) with at least two parts is provided. The at least two-part rotor (2) is mounted such that it can rotate about an axis (A) and consists of a first rotor element (4) and a second rotor element (6). At least one first, second and/or a third drainage recess (8, 10, 12) is formed in the first and/or second rotor element (4, 6), such that oil can be discharged from a contact surface (14) of the first and second rotor elements (4, 6) of the camshaft adjuster (1) to the outer side (16) of the first and/or second rotor elements (4, 6).

The present invention relates to a hydraulic camshaft adjuster which includes an at least two-part rotor. The at least two-part rotor is rotatably movable around an axis and includes a first rotor element and a second rotor element.

The present invention also relates to a use of an at least two-part rotor in a hydraulic camshaft adjuster.

The present invention furthermore relates to a method for operating a hydraulic camshaft adjuster including an at least two-part rotor.

### BACKGROUND

It is generally known that camshaft adjusters permit optimum valve timing across a broad range of loads and rotational speeds of an engine. Significant reductions in emissions and fuel consumption are thus implemented. In addition, driving pleasure is significantly increased by optimizing the torque and power. According to the prior art, a distinction is made between electrical camshaft adjusters and the hydraulic camshaft adjusters mentioned at the outset.

In the area of hydraulic camshaft adjusters, rotors are known which include a first rotor element and a second rotor element. This is disclosed, for example, in the German unexamined patent application DE 10 2009 053 600 A1. In this case, the two rotor elements are connected with the aid of pins or sintered.

Another specific embodiment for connecting two rotor elements of a rotor is described in the German unexamined patent application DE 10 2008 028 640 A1. Two rotor elements are provided here in such a way that they may be joined together on the basis of their “own” particular geometry. Two rotor elements, which seal oil channels due to sintered bevels and are thus connected to each other, are disclosed in the German unexamined patent application DE 10 2011 117 856 A1. In addition, the European patent specification EP 2 300 693 B1 describes two identical, joined rotor elements, which have a form fit and a press fit to form the oil channels. A design of the rotor as an assembly system is disclosed in the European patent specification EP 1 731 722 B1, the rotor core and the cover forming the oil channels.

In the aforementioned publications, the oil penetrating the joint generates a pressure on the two rotor contact surfaces and thus spreads apart the joined rotor elements. In addition to oil leaks, the penetrating oil also induces additional stresses and deformations of the two rotor elements. As illustrated in a perspective view in FIGS. 1 and 2, this results, for example, in forcing apart the two rotor elements 4, 6 or vanes 7 mounted on rotor elements 4, 6.

### SUMMARY OF THE INVENTION

One object of the present invention is therefore to further develop a cost-effective hydraulic camshaft adjuster, which includes an at least two-part rotor, in such a way that the latter reduces oil leaks in the camshaft adjuster and also relieves the at least two-part rotor of additional oil pressure.

The present invention provides a hydraulic camshaft adjuster which includes an at least two-part rotor.

Another object of the present invention is to provide a use of an at least two-part rotor in a hydraulic camshaft adjuster, so that oil leaks in the camshaft adjuster are reduced during operation and the at least two-part rotor is relieved of additional oil pressure.

The present invention also provides use of an at least two-part rotor in a hydraulic camshaft adjuster.

Another object of the present invention is to provide a cost-effective method for operating a hydraulic camshaft adjuster, which reduces oil leaks in the camshaft adjuster during operation and relieves the at least two-part rotor of additional oil pressure.

The present invention also provides a manufacturing method for operating a hydraulic camshaft adjuster.

The hydraulic camshaft adjuster, including an at least two-part rotor, is rotatably movable around an axis and includes a first rotor element and a second rotor element.

According to the present invention, at least one first drainage recess, a second drainage recess and/or a third drainage recess are formed in the first and/or second rotor element, so that oil is dischargeable from a contact surface of the first and second rotor elements of the camshaft adjuster to an outside of the first and/or second rotor element.

In one first specific embodiment of the present invention, the at least one drainage recess is at least one drainage channel which runs axially from an inside to the outside of the first and/or second rotor element, so that the oil is dischargeable to the outside of the first and/or second rotor element.

According to another specific embodiment of the hydraulic camshaft adjuster, the at least one first drainage recess is at least one drainage channel which runs radially on an inside and/or the outside of the first and/or second rotor element. The at least one drainage channel in this case is designed, for example, in the form of an indentation on an inside and/or the outside of the first and/or second rotor element. To be able to ensure that the oil is dischargeable from the contact surface of the first and second rotor elements, this indentation is connected to at least one drainage recess which discharges the oil to the outside of the first and/or second rotor element.

In another specific embodiment of the present invention, the at least one second drainage recess is at least one drainage bore, which runs axially from an inside to the outside of the first and/or second rotor element and is provided in vanes of the first and/or second rotor element and communicates with at least one drainage channel, so that the oil is dischargeable to the outside of the first and/or second rotor element. In particular, the present invention then provides that the at least one drainage bore is combinable with other function elements in the vanes of the first and/or second rotor element. It is thus conceivable that drainage bores are combined with function elements such as weight reducers, bores for spring suspensions, venting channels for a locking pin, etc. In particular, another specific embodiment provides that the at least one drainage bore is connected to a recess, which runs to an outside of the first and/or second rotor element.

In another specific embodiment of the present invention, the at least one third drainage recess is at least one drainage bore, which runs axially from an inside to the outside of the first and/or second rotor element and is provided in the first and/or second rotor element between vanes of the first and/or second rotor element.

In another preferred specific embodiment, the first and second rotor elements are connected to each other with the aid of an oil distribution and centering sleeve, so that the at least two-part rotor may be easily and quickly mounted in the hydraulic camshaft adjuster.

According to another specific embodiment of the present invention, the at least one drainage channel is situated at a radial distance of at least 2 to 3 mm from an inner wall of the first and/or second rotor element, so that a sealing area of 2 to 3 mm is formed in the two-part rotor. This sealing area is therefore designed to be a minimum of 2 to 3 mm so that dirt particles in the oil may accumulate in the at least one drainage channel and do not build up on the sealing area, depending on the rotation direction of a camshaft of the camshaft adjuster. A wear is avoidable thereby, and a long-lasting sealing effect is achievable.

The method according to the present invention for operating a hydraulic camshaft adjuster, including an at least two-part rotor, is characterized by the following step according to the present invention: Oil is discharged from a contact surface of the first and second rotor elements of the camshaft adjuster to an outside of the first and/or second rotor element through at least one first drainage recess, a second drainage recess and/or a third drainage recess in a first and/or a second rotor element.

In the present invention, the pressure between the rotor contact surfaces in the joint is thus advantageously reduced by the at least one first, second and/or third drainage recess in the first and/or second rotor element, so that the problem of forcing the two rotor elements apart, which universally occurs in the prior art, is eliminated. Consequently, oil leaks in the hydraulic camshaft adjuster are reduced thereby. Due to this present invention, it is furthermore advantageous that no additional components are needed on the first and/or second rotor element of an at least two-part rotor of a camshaft adjuster.

### BRIEF DESCRIPTION OF THE DRAWINGS

Exemplary embodiments of the present invention and their advantages are explained in greater detail below on the basis of the attached figures. The proportions in the figures do not always correspond to the real proportions, since some shapes have been simplified and other shapes have been enlarged in relation to other elements for the purpose of better clarification.

FIGS. 1 and 2 show perspective views of a two-part rotor of a hydraulic camshaft adjuster, which is known from the prior art;

FIG. 3 shows a top view of one specific embodiment of the hydraulic camshaft adjuster according to the present invention;

FIG. 4 shows a sectional view along line A-A from FIG. 3 of one specific embodiment of the hydraulic camshaft adjuster according to the present invention, including an at least two-part rotor;

FIGS. 5 and 6 show exploded views of another specific embodiment of the hydraulic camshaft adjuster according to the present invention, including an at least two-part rotor;

FIG. 7 shows a top view of an outside of the first rotor element from FIGS. 5 and 6;

FIG. 8 shows a top view of an inside of the first rotor element from FIGS. 5 and 6;

FIG. 9 shows a perspective view of the inside of the first rotor element from FIGS. 5 and 6;

FIG. 10 shows perspective views of the outside of the first rotor element from FIGS. 5 and 6;

FIGS. 11 and 12 show perspective views of the completely mounted, two-part rotor from FIGS. 5 and 6.

### DETAILED DESCRIPTION

Identical reference numerals are used for the same elements or elements having the same function. Furthermore, for the sake of clarity, only reference numerals which are necessary for describing the particular figure are shown in the individual figures. The illustrated specific embodiments represent only examples of how the hydraulic camshaft adjuster according to the present invention, the use according to the present invention of an at least two-part rotor and the method according to the present invention for operating a hydraulic camshaft adjuster could be designed, and they thus do not represent a final limitation of the present invention.

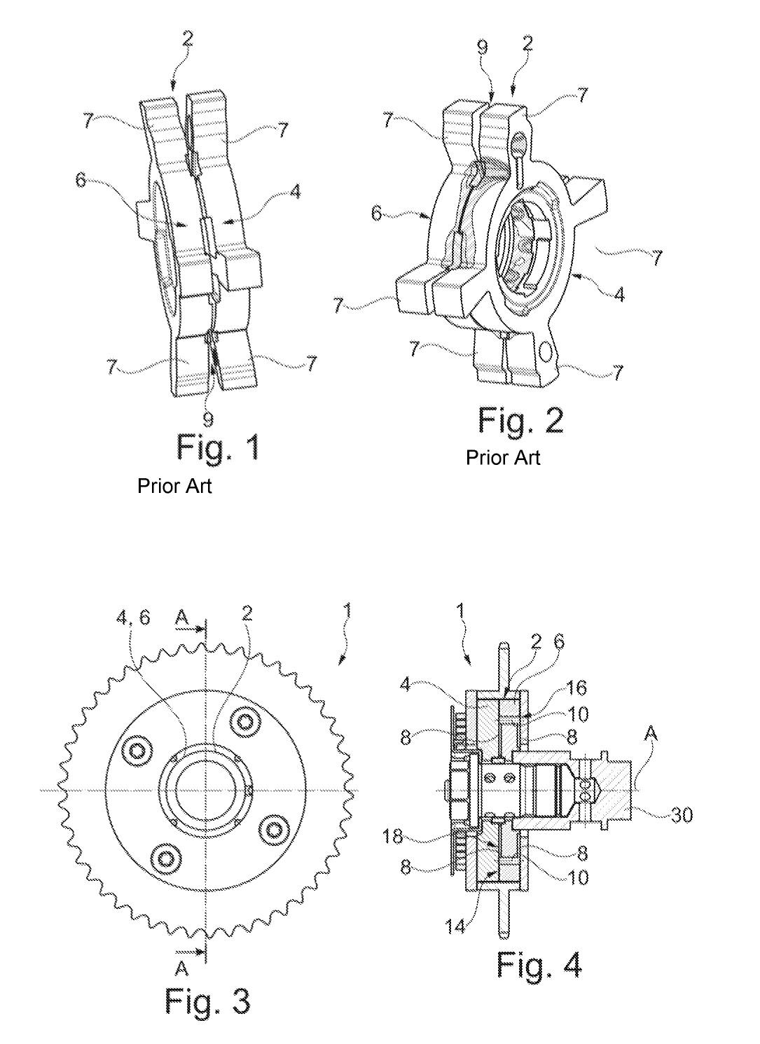

FIGS. 1 and 2 show perspective views of a two-part rotor 2, known from the prior art, of a hydraulic camshaft adjuster 1 (not illustrated), in which two rotor element 4, 6 are forced apart due to pressure resulting from an oil penetrating joint 9. Since this problem, which occurs in the prior art, has already been described at the outset, a further description at this point will be dispensed with.

FIG. 3 shows a top view and FIG. 4 a sectional view along line A-A from FIG. 3 of a first specific embodiment of the hydraulic camshaft adjuster 1 according to the present invention, including an at least two-part rotor 2. The at least two-part rotor 2 is rotatably movable around an axis A and includes a first rotor element 4 and a second rotor element 6.

According to the present invention, this specific embodiment provides two second drainage recesses in the form of two drainage bores 10 in second rotor element 6, which run axially from an inside 18 to an outside 16 of second rotor element 6 and which each communicate with one first drainage recess in the form of drainage channels 8, which run radially on inside 18 and radially on outside 16 of second rotor element 6, so that oil is dischargeable from a contact surface 14 between first and second rotor elements 4, 6 of camshaft adjuster 1 to outside 16 of second rotor element 6. The pressure resulting from the oil flow between the two rotor elements 4, 6 may be reduced by these two drainage bores 10 in second rotor element 6, so that these two elements 4, 6 are no longer forced apart during operation.

Other specific embodiments may provide only one or more than two drainage bores 10 in the area of vanes 7, fewer or more than four drainage channels 8 in second rotor element 6. Likewise, it is also conceivable in other specific embodiments that these drainage bores 10 are formed only in first rotor element 4 or even in both rotor elements 4, 6.

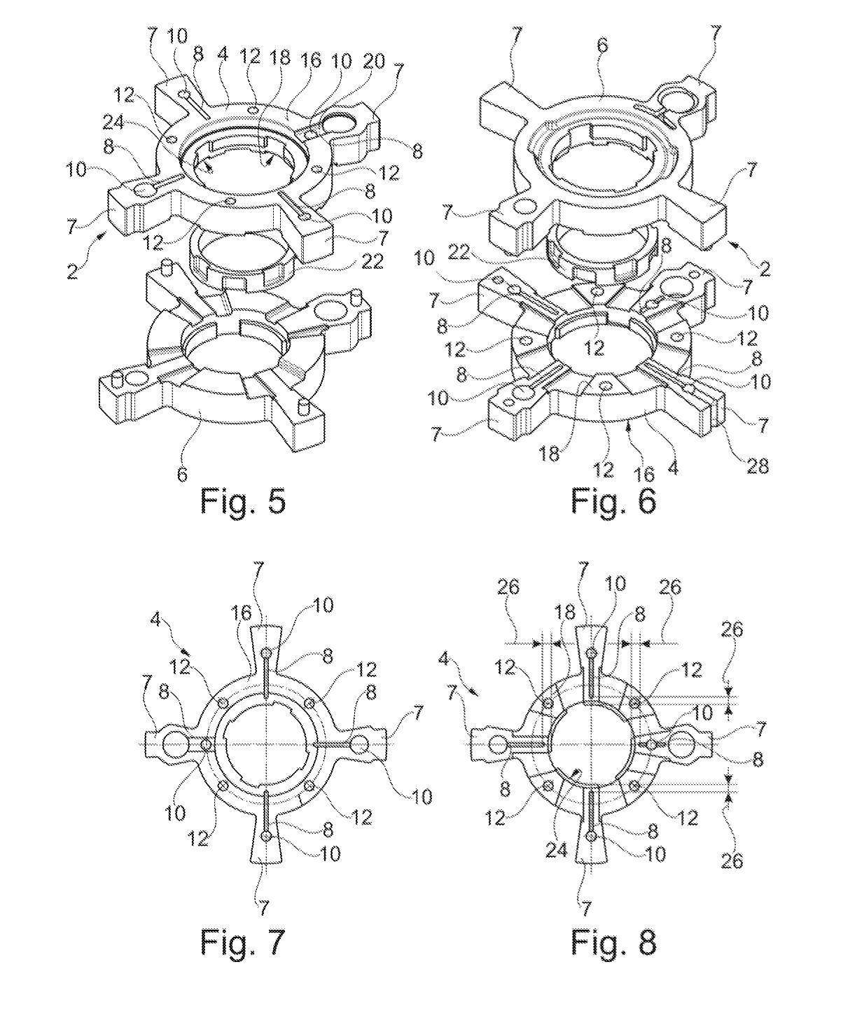

FIG. 5 and FIG. 6 show exploded views of another specific embodiment of hydraulic camshaft adjuster 1 (see FIG. 4) according to the present invention, including an at least two-part rotor 2. To be able to easily and quickly mount at least two-part rotor 2 in hydraulic camshaft adjuster 1, this specific embodiment provides that first and second rotor elements 4, 6 are connected to each other with the aid of an oil distribution and centering sleeve 22. In this specific embodiment, first rotor element 4 furthermore includes a total of twelve first, second and third drainage recesses 8, 10, 12 according to the present invention, so that oil is dischargeable from a contact surface 14 (see FIGS. 4, 11 and 12) of first and second rotor elements 4, 6 of camshaft adjuster 1 to an outside 16 of first rotor element 4.

Eight of the twelve drainage recesses 8, 10, 12 are second and third drainage recesses 10, 12, i.e. drainage bores, which run axially from an inside 18 to outside 16 of first rotor element 4. In particular, four second drainage recesses 10 are designed in such a way that four drainage bores 10 are provided in vanes 7 of first rotor element 4 and communicate with four first drainage recesses in the form of drainage channels 8.

In this case, one of four first drainage bores 10 are furthermore designed in such a way that they are combinable with another function element 20, such as a venting channel 20 for a locking pin. It is likewise provided here that another of the four drainage bores 10 is connected to a recess 28, which runs to an outside 16 of first rotor element 4.

The remaining four third drainage recesses in the form of drainage bores 12 for the purpose of also discharging oil from a contact surface 14 of first and second rotor elements 4, 6 of camshaft adjuster 1 to outside 16 of first rotor element 4 are provided in first rotor element 4 between vanes 7.

As is already described, four drainage channels 8 extend axially from inside 18 to outside 16 of first rotor element 4 in the specific embodiment illustrated here. In another specific embodiment, however, it is also conceivable that these drainage channels 8 run radially on inside 18 and/or outside 16 of first and/or second rotor element 4, 6, i.e., they form only a kind of indentation.

To prevent dirt particles in the oil from accumulating in a sealing area 26, the latter is designed to be a minimum of 2 to 3 mm, as shown in FIG. 8, so that these dirt particles accumulate in drainage channels 8, depending on the rotation direction of a camshaft 30 (see FIG. 4) of camshaft adjuster 1. Four drainage channels 8 are thus formed at a radial distance of at least 2 to 3 mm from inner wall 24 of first rotor element 4.

In other specific embodiments, more or fewer than eight drainage bores 10, 12 or more or fewer than four drainage channels 8 are also conceivable, so that a multitude of specific embodiments is conceivable. However, these embodiments are not listed, since they are self-evident to those skilled in the art.

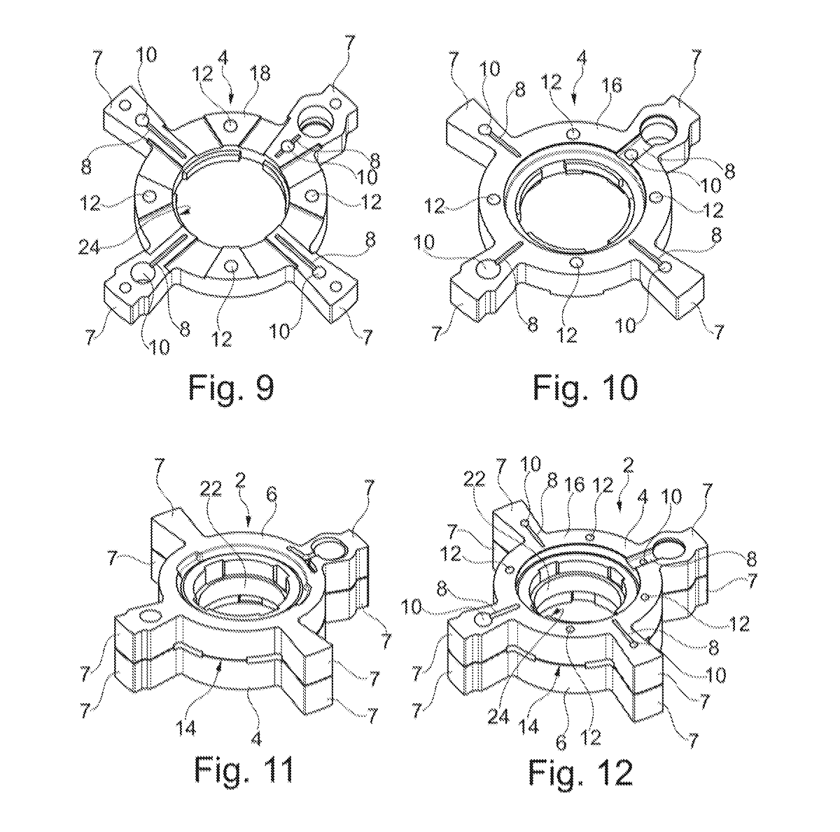

FIG. 7 shows a top view and FIG. 10 a perspective view of an outside 16 of first rotor element 4 from FIGS. 5 and 6, while FIG. 8 shows a top view and FIG. 9 a perspective view of an inside 18 of first rotor element 4 from FIGS. 5 and 6. Since the reference numerals illustrated in the FIGS. 7 through 10 have already been described in relation to the preceding FIGS. 5 and 6, they will not be described again at this point. The same applies to FIGS. 11 and 12, since they show perspective views of completely mounted, two-part rotor 2 according to FIGS. 5 and 6.

### LIST OF REFERENCE NUMERALS

1 hydraulic camshaft adjuster
2 rotor
4 first rotor element
6 second rotor element
7 vane
8 drainage recess, drainage channel
9 joint
10 drainage recess, first drainage bore
12 drainage recess, second drainage bore
14 contact surface
16 outside
18 inside
29 function element
22 oil distribution and centering sleeve
24 inner wall
26 sealing area
28 recess
30 camshaft
A axis

1-10. (canceled)

11. A hydraulic camshaft adjuster comprising:
an at least two-part rotor rotatably movable around an axis and including a first rotor element and a second rotor element;
at least one first drainage recess, one second drainage recess or one third drainage recess formed in the first or second rotor element, so that oil is dischargeable from a contact surface of the first and second rotor elements of the camshaft adjuster to an outside of the first or second rotor element.

12. The hydraulic camshaft adjuster as recited in claim 11 wherein the at least one first drainage recess is a drainage channel running axially from an inside to the outside of the first or second rotor element.

13. The hydraulic camshaft adjuster as recited in claim 11 wherein the at least one first drainage recess is at least one drainage channel running radially on an inside or the outside of the first or second rotor element.

14. The hydraulic camshaft adjuster as recited in claim 11 wherein the at least one second drainage recess is at least one drainage bore running axially from an inside to the outside of the first or second rotor element and is provided in vanes of the first or second rotor element and communicates with at least one drainage channel.

15. The hydraulic camshaft adjuster as recited in claim 14 wherein the at least one drainage bore is combinable with other function elements in the vanes of the first or second rotor element.

16. The hydraulic camshaft adjuster as recited in claim 15 wherein the at least one drainage bore is connected to a recess running to an outside of the first or second rotor element.

17. The hydraulic camshaft adjuster as recited in claim 11 wherein the at least one third drainage recess is at least one drainage bore running axially from an inside to the outside of the first or second rotor element, and is provided in the first or second rotor element between vanes of the first or second rotor element.

18. The hydraulic camshaft adjuster as recited in claim 12 wherein the at least one drainage channel is formed at a radial distance of at least 2 to 3 mm from an inner wall of the first or second rotor element, so that a sealing area of 2 to 3 mm is formed in the two-part rotor.

19. A method for operating a hydraulic camshaft adjuster as recited in claim 11 comprising moving the at least two-part rotor in the hydraulic camshaft adjuster.

20. A method for operating a hydraulic camshaft adjuster as recited in claim 11 comprising:
discharging oil from a contact surface of the first and second rotor elements of the camshaft adjuster to an outside of the first or second rotor element through the at least one first drainage recess, one second drainage recess or one third drainage recess in the first or in the second rotor element.
